(19) United States
(12) Patent Application Publication
(10) Pub. No.: US 2026/0071573 A1
(43) Pub. Date: Mar. 12, 2026

(54) FUEL SYSTEM FOR A GAS TURBINE ENGINE, AND GAS TURBINE ENGINE

(71) Applicant: Rolls-Royce Deutschland Ltd & Co KG, Blankenfelde-Mahlow (DE)

(72) Inventors: Thomas JÄGER, Teltow (DE); Markus BLUMRICH, Berlin (DE)

(21) Appl. No.: 19/321,674

(22) Filed: Sep. 8, 2025

(30) Foreign Application Priority Data
Sep. 9, 2024 (DE) 10 2024 125 769.5

(51) Int. Cl. F02C 7/22; B01D 35/153; B01D 35/157; B01D 35/26; B64D 37/00; B64D 37/02

(52) U.S. Cl. CPC F02C 7/22; B01D 35/153; B01D 35/1573; B01D 35/26; B64D 37/005; B64D 37/02; B01D 2201/167; B01D 2201/265

(57) ABSTRACT

A fuel system for a gas turbine engine, includes a fuel line connecting a fuel tank to s feed pump and a fuel filter. The fuel filter is downstream of the feed pump and connected via the fuel line to a pressure side of the feed pump and a combustion chamber. A return line branches from the combustion chamber toward a return reservoir. A suction charging line connects the pressure side of the feed pump to a suction side of the feed pump. The return reservoir is operatively connected to the suction charging line via an emptying unit for conducting fuel from the return reservoir into the suction charging line. The suction charging line branches from the fuel filter toward the suction side of the feed pump and fuel can be introduced from an interior of a filter housing of the fuel filter into the suction charging line.

This application claims priority to German Patent Application 10 2024 125 769.5 filed Sep. 9, 2024, the entirety of which is incorporated by reference herein.

The present disclosure relates to a fuel system for a gas turbine engine, and to a gas turbine engine.

U.S. Pat. No. 6,371,087 B1 relates to a fuel filter drainage system that continuously pumps filtered water from a fuel filter of a locomotive diesel engine. The system furthermore comprises a drainage unit arranged at the bottom of an end cap next to a water collection region in the fuel filter. The water is forced out of the fuel filter due to the sufficient pressure differential in the filter system.

An apparatus and a method for multistage water separation and fuel filtration are known from U.S. Pat. No. 7,527,739 B2. The apparatus comprises two sedimentation chambers for collecting the water droplets from the fuel, a drainage opening at the distal end for draining the water droplets present in the sedimentation chamber and a tension spring, which releases the collected water from the drainage opening when compressed.

In addition, CN 110 397 530 B discloses a drainage system and a drainage method for an engine fuel filter. The drainage system comprises a cup body provided with a water outlet and a valve arrangement arranged on the cup body. The system also comprises an air compressor arrangement that drives the valve arrangement for the purpose of opening the water outlet.

In addition, a gas turbine engine for aircraft that is known from practice has a fuel system comprising a fuel line. The fuel line connects a fuel tank to at least one feed pump and to a fuel filter connected to a pressure side of the feed pump and arranged downstream of the feed pump. Dirt particles are filtered out of the fuel in the region of the fuel filter. Furthermore, downstream the fuel line fluidically connects the fuel filter to a combustion chamber. The combustion chamber is connected to a return reservoir via a return line when the gas turbine engine is switched off. The fuel line is then emptied in the direction of the return reservoir due to the pressure in the combustion chamber. In addition, a suction charging line is provided which, upstream or downstream of the fuel filter, connects the pressure side of the feed pump to a suction side of the feed pump. The return reservoir is operatively connected to the suction charging line via an emptying unit. The emptying unit is configured to conduct fuel from the return reservoir into the suction charging line in order to empty the return reservoir.

The water entrained in the fuel is at least partially separated off in the fuel filter and accumulates in the lower region of the fuel filter due to its higher density compared to the density of the fuel. A problem here is that, at operating temperatures of below 0° C. in the region of the fuel filter, the volume of water accumulated in the fuel filter freezes in the fuel filter and reduces the capacity of the fuel filter or completely clogs the fuel filter.

It is also possible that the water accumulated in the fuel filter is spontaneously flushed out of the fuel filter, freezing in the region of elements arranged downstream of the fuel filter in the fuel line and interfering with a fuel supply.

The present disclosure is based on the object of providing a fuel system and a gas turbine engine in which undesirably large accumulations of water in the fuel system are avoided in a structurally simple and cost-effective manner.

This object is achieved by a fuel system and by a gas turbine engine having the features of claims 1 and 12, respectively.

The fuel system for a gas turbine engine, in particular for an aircraft gas turbine, according to the present disclosure comprises a fuel line. The fuel line connects a fuel tank to at least one feed pump and to a fuel filter. The fuel filter is arranged downstream of the feed pump and is connected to a pressure side of the feed pump. In addition, the fuel line connects the fuel filter to a combustion chamber. A return line branches off from the combustion chamber in the direction of a return reservoir. A suction charging line connects the pressure side of the feed pump to a suction side of the feed pump. The return reservoir is operatively connected to the suction charging line via an emptying unit, wherein the emptying unit is configured to conduct fuel from the return reservoir into the suction charging line.

Since the suction charging line branches off from the fuel filter in the direction of the suction side of the feed pump and fuel can be introduced from an interior of a filter housing of the fuel filter into the suction charging line, during operation of the fuel system, starting from the pressure side of the feed pump in the direction of the suction charging line, fuel conveyed by the feed pump flows permanently through the filter housing in the direction of the suction side of the feed pump. As a result, relatively large accumulations of water, which in conventional solutions cause the known problems in the region of a fuel filter and also downstream of the fuel filter, are avoided in the fuel filter with little outlay in terms of construction and thus in a simple and cost-effective manner.

In an advantageous development of the fuel system according to the present disclosure, the suction charging line branches off from a lower region of the filter housing when the fuel filter is in an installed position. This allows a volume of water accumulated in the filter housing to be kept to a minimum in a structurally simple manner.

If the suction charging line is connected to the interior of the filter housing through a lower cover element, stagnation zones in the interior of the filter housing that promote accumulations of water are avoided with little effort.

Alternatively, the suction charging line can also be connected to the interior of the filter housing through a side wall of the fuel filter, in order to flush the interior of the fuel filter with fuel starting from the pressure side of the feed pump in the direction of the suction charging line and thus of the suction side of the feed pump during operation of the fuel system.

A retention unit, in the region of which dirt particles are retained in the filter housing, can be arranged upstream of an opening of the filter housing, which opening connects the interior of the filter housing to the suction charging line. It is thus achieved with little effort that dirt particles do not circulate in the fuel system and that the function of components of a gas turbine engine that are sensitive to dirt particles is not impaired.

The retention device may comprise an impingement wall, which is arranged in the flow path between the interior of the filter housing and the suction charging line and upstream of the opening of the filter housing and in the region of which dirt particles entrained in the fuel are separated off with little effort.

In addition or as an alternative to this, it may be provided that the retention device comprises a filter element, which is arranged in the region of the opening of the filter housing and through which the fuel which is conducted from the interior of the fuel filter into the suction charging line flows and which retains dirt particles entrained with the fuel.

A float element of the emptying unit may be arranged in the return reservoir and blocks an emptying line below a defined fuel filling level of the return reservoir, which emptying line connects the return reservoir to the suction charging line. This avoids, in a simple manner, drawing in air from the return reservoir.

In an embodiment of the fuel system according to the present disclosure, which can be operated substantially without wear at least in some regions, a jet pump of the emptying unit is arranged in the suction charging line. The jet pump can be connected to the return reservoir via an emptying line. It is possible here that the fuel conducted through the suction charging line during operation of the fuel system forms the driving medium of the jet pump and the fuel stored in the return reservoir forms the suction medium of the jet pump.

The emptying unit may have a check valve, which blocks the connection between the return reservoir and the jet pump when the pressure in the return reservoir falls below the suction pressure of the jet pump. This avoids fuel being conducted from the suction charging line in the direction of the return reservoir during unfavourable operating state profiles of the fuel system without additional outlay in terms of open-loop and closed-loop control.

The return line may have a valve unit in a line region close to the combustion chamber, via which valve unit a connection between the combustion chamber and the return reservoir is switchable.

A further aspect of the present disclosure relates to a gas turbine engine which is equipped with a fuel system described in more detail above.

The invention is not limited to the indicated combinations of features in the independent claims or in the claims dependent thereon. Within the scope of the claims, there are furthermore possibilities of combining individual features, in so far as they are apparent from the claims, the following description of embodiments or directly from the drawing. The reference to the drawings by the claims through the use of reference signs is not intended to limit the scope of protection of the claims.

Preferred developments will become apparent from the dependent claims and the following description. Exemplary embodiments of the invention are explained in more detail with reference to the drawing, without being limited thereto.

In the figures:

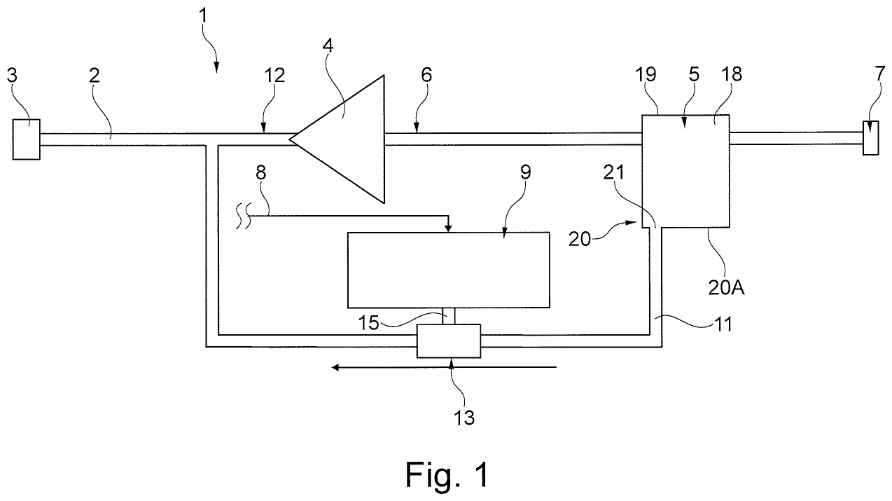

FIG. 1 shows a greatly simplified partial illustration of a first embodiment of a fuel system of a gas turbine engine;

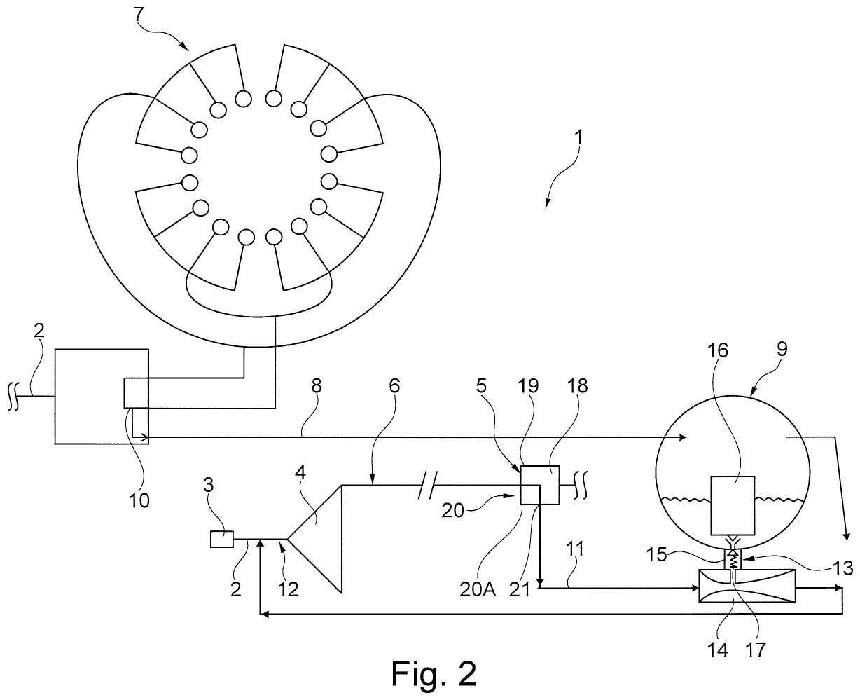

FIG. 2 shows a further partial illustration of the fuel system according to FIG. 1;

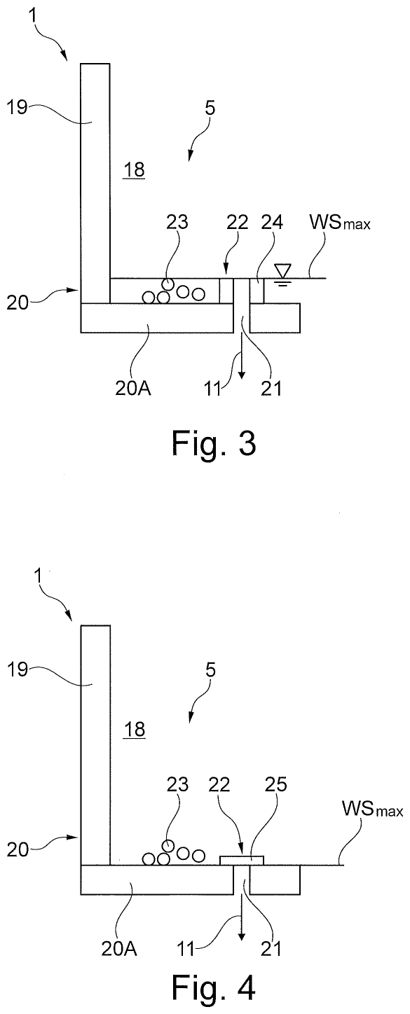

FIG. 3 shows a schematic partial sectional view of a first embodiment of a fuel filter of the fuel system according to FIG. 1;

FIG. 4 shows an illustration corresponding to FIG. 3 of a second embodiment of the fuel filter of the fuel system according to FIG. 1;

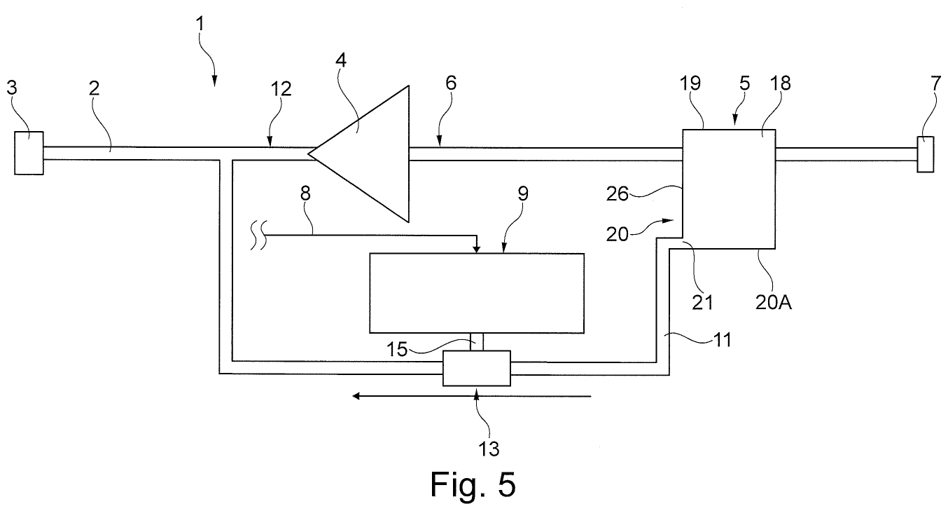

FIG. 5 shows an illustration corresponding to FIG. 1 of a second embodiment of the fuel system;

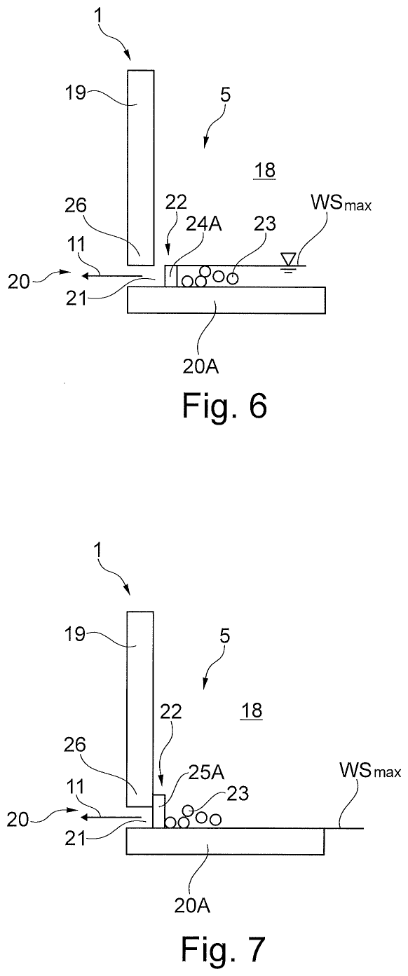

FIG. 6 shows an illustration corresponding to FIG. 3 of a first embodiment of the fuel filter of the fuel system according to FIG. 5;

FIG. 7 shows an illustration corresponding to FIG. 6 of a second embodiment of the fuel filter of the fuel system according to FIG. 5; and

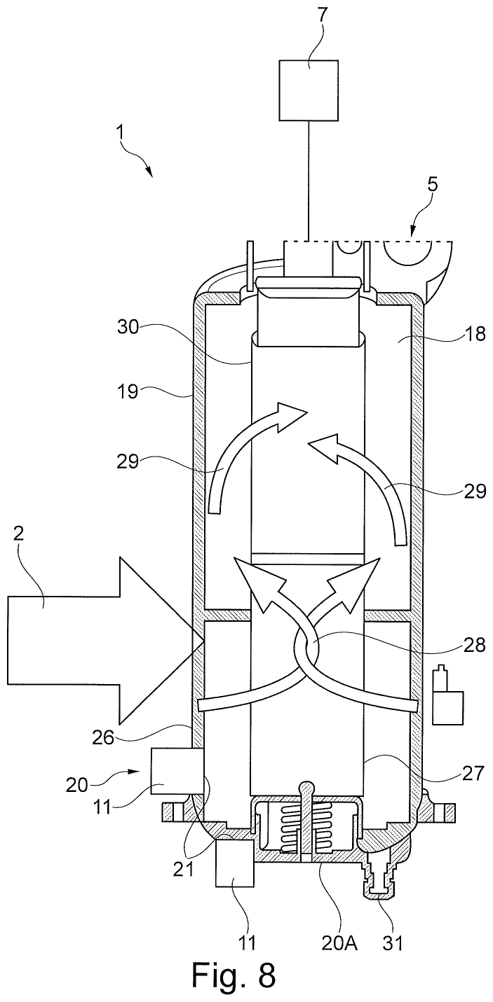

FIG. 8 shows a simplified sectional view of a further embodiment of the fuel filter.

FIG. 1 shows a simplified partial illustration of a fuel system 1 of a gas turbine engine, in particular a gas turbine engine of an aircraft. A fuel line 2 of the fuel system 1 connects a fuel tank 3 to a feed pump 4 and to a fuel filter 5 arranged downstream of the feed pump 4 and connected to a pressure side 6 of the feed pump 4. During operation of the fuel system 1, fuel flows downstream of the feed pump 4 into the fuel filter 5, with dirt particles being separated off from the fuel in the fuel filter 5.

Furthermore, the fuel line 2 connects the fuel filter 5 fluidically to a combustion chamber 7 which is arranged downstream of the fuel filter 5, is illustrated in more detail in FIG. 2 and is supplied, via the fuel line 2, with the fuel cleaned in the fuel filter 5. The combustion chamber 7 is connected to a return reservoir 9 via a return line 8 when the gas turbine engine and the feed pump 4 are switched off. The fuel line 2 is then emptied by way of the pressure in the combustion chamber 7 in the direction of the return reservoir 9, which is filled accordingly with fuel. For this, a valve unit 10 is provided in a line region of the return line 8 close to the combustion chamber 7, via which valve unit the connection between the combustion chamber 7 and the return reservoir 9 is switchable.

In addition, a suction charging line 11 is provided, via which the pressure side 6 of the feed pump 4 is connected to a suction side 12 of the feed pump 4. The suction charging line 11 in this case branches off from the fuel filter 5 and thus from the fuel line 2 in the direction of the suction side 12 of the feed pump 4. The return reservoir 9 is operatively connected to the suction charging line 11 via an emptying unit 13. The emptying unit 13 is configured to conduct fuel from the return reservoir 9 into the suction charging line 11 in order to empty the return reservoir 9. For this, the emptying unit 13 comprises a jet pump 14, which is arranged in the suction charging line 11 and through which, during operation of the fuel system 1, the fuel which is conducted through the suction charging line 11 flows starting from the fuel filter 5 in the direction of the suction side 12 of the feed pump 4. Thus, the fuel flowing through the suction charging line 11 represents the driving medium of the jet pump 14.

Between the return reservoir 9 and the jet pump 14 of the emptying unit 13 runs an emptying line 15, via which fuel stored in the return reservoir 9, which represents the suction medium of the jet pump 14, can be drawn in by the jet pump 14. In order to prevent the drawing in of air from the return reservoir 9, a float element 16 of the emptying unit 13 is arranged in the return reservoir 9. The float element 16 blocks the emptying line 13 below a defined fuel filling level of the return reservoir 9 and opens up the emptying line 13 above the fuel filling level.

Furthermore, the emptying unit 13 contains a check valve 17, which blocks the connection between the return reservoir 9 and the jet pump 14 when the pressure in the return reservoir 9 falls below the suction pressure of the jet pump. This avoids fuel being conducted from the suction charging line 11 in the direction of the return reservoir 9 during unfavourable operating state profiles of the fuel system 1 without additional outlay in terms of open-loop and closed-loop control.

In addition to dirt particles, water entrained in the fuel is also at least partially separated off in the fuel filter 5 and tends to accumulate in the lower region of the fuel filter 5 due to its higher density compared to the density of the fuel. During operation of the fuel system 1, fuel is not only conducted in the direction of the combustion chamber 7 from an interior 18 of a filter housing 19 of the fuel filter 5, but fuel is also introduced into the suction charging line 11 in a lower region 20 of the fuel filter 5. As a result, during operation of the fuel system 1, fuel conveyed by the feed pump 4 flows continuously through the filter housing 19 from the pressure side 6 of the feed pump 4 in the direction of the suction side 12 of the feed pump 4, and water separated off from the fuel in the fuel filter 5 is flushed out in the direction of the suction side 12.

It is possible here that an opening region 11A of the suction charging line 11 is arranged in a lower cover element 20A of a lower region 20 of the filter housing 19 in the manner illustrated in FIG. 3 and FIG. 4 when the fuel filter 5 is in an installed position. This ensures that a volume of what is known as a stagnation zone in the interior 18 is minimal. Due to the design, the stagnation zone is not covered by the flushing flow during operation of the fuel system 1. Therefore, only a small volume of water accumulates in the filter housing 19, which does not adversely affect the function of the fuel filter 5 or of the fuel system 1.

A retention unit 22 is arranged upstream of an opening 21 of the filter housing 19, which opening connects the interior 18 of the filter housing 19 to the suction charging line 11. In the region of the retention unit 22, dirt particles 23 are retained in the filter housing 19. In the embodiment of the retention unit 22 illustrated in FIG. 3, the retention unit comprises an impingement wall 24, which surrounds the opening 21, is arranged in the flow path between the interior 18 of the filter housing 19 and the suction charging line 11 and upstream of the opening 21 of the filter housing 19, and in the region of which dirt particles 23 entrained in the fuel are separated off. A maximum water filling level WSmax is established in the interior 18 due to the impingement wall 24.

The embodiment of the retention unit 22 illustrated in FIG. 4 contains a filter element 25, which is arranged in the region of the opening 21 of the filter housing 19. The filter element 25 has the fuel which is conducted from the interior 18 of the fuel filter 5 into the suction charging line 11 flowing through it and retains dirt particles 23 which are introduced into the fuel filter 5 by the fuel. Due to the filter element 25, the maximum water filling level WSmax in the interior 18 is substantially lower than in the design of the fuel filter 5 according to FIG. 3.

FIG. 5 shows a further embodiment of the fuel system 1, in which the suction charging line 11 is attached to a side wall 26 of the fuel filter 5. The opening 21 is provided in the side wall 26 just above the cover element 20A and establishes a connection between the interior 18 of the filter housing 19 and the suction charging line 11.

It is possible here that the retention unit 22 is equipped with an impingement wall 24A as shown in FIG. 6 or with a filter element 25A as illustrated in FIG. 7 in order to be able to separate off the dirt particles 23 from the fuel in the interior 18 before they enter the suction charging line 11.

A further embodiment of the fuel filter 5 is illustrated in FIG. 8, in which the fuel is introduced above the opening 21, through the side wall 26, into the interior 18 of the filter housing 19. In the interior 18, a portion of the introduced fuel volume flows through a filter medium 27 in the direction of the arrows 28, first from the outside to the inside and then from the inside to the outside. Subsequently, this portion of the fuel flows through a further filter medium 30 in the direction of the arrows 29 from the outside to the inside and is then discharged from the fuel filter 5 in the direction of the combustion chamber 7. The other portion of the fuel volume introduced into the interior 18 flows off via the opening 21 either laterally or downwards into the suction charging line 11. In addition, the fuel filter 5 according to FIG. 8 contains a drainage screw 31 via which, in the event of maintenance, fuel in the fuel filter 5 can be drained with little effort.

The feed pump 4 can be in the form of a low-pressure pump, which is arranged upstream of a further feed pump designed as a high-pressure pump in the fuel line 2. The high-pressure pump supplies the combustion chamber 7 with fuel at a pressure that allows efficient combustion. In such an embodiment of the fuel system 1, a pressure loss in the region of the fuel filter 5 is compensated via the feed pump 4 in order to be able to apply inlet pressures greater than a defined pressure threshold to the high-pressure pump. This avoids cavitation in the region of the high-pressure pump in a simple manner.

If a further fuel filter is arranged downstream of the high-pressure pump in the same way as that of the feed pump 4, the further fuel filter can be flushed with fuel from the pressure side in the direction of the suction side of the high-pressure pump via a further suction charging line to prevent undesirable accumulations of water to the same extent as the fuel filter 5.

Depending on the present usage situation, it is also possible for the feed pump 4 itself to be designed as such a high-pressure pump and for the fuel system 1 to contain only one feed pump.

### LIST OF REFERENCE SIGNS

1 Fuel system
2 Fuel line
3 Fuel tank
4 Feed pump
5 Fuel filter
6 Pressure side of feed pump 4
7 Combustion chamber
8 Return line
9 Return reservoir
10 Valve unit
11 Suction charging line
12 Suction side of feed pump 4
13 Emptying unit
14 Jet pump
15 Emptying line
16 Float element
17 Check valve
18 Interior of filter housing
19 Filter housing
20 Lower region of filter housing
20A Cover element
21 Opening of filter housing
22 Retention unit
23 Dirt particles
24 Impingement wall
24A Impingement wall
25 Filter element
25A Filter element
26 Side wall of fuel filter
27 Filter medium
28 Arrow
29 Arrow
30 Further filter medium
31 Drainage screw
WSmax Maximum water filling level

1. A fuel system for a gas turbine engine, in particular for an aircraft gas turbine, comprising a fuel line, which connects a fuel tank to at least one feed pump, to a fuel filter arranged downstream of the feed pump and connected to a pressure side of the feed pump, and to a combustion chamber connected to the fuel line downstream of the fuel filter, and comprising a return line, which branches off from the combustion chamber in the direction of a return reservoir, and comprising a suction charging line, which connects the pressure side of the feed pump to a suction side of the feed pump, wherein the return reservoir is operatively connected to the suction charging line via an emptying unit, wherein the emptying unit is configured to conduct fuel from the return reservoir into the suction charging line, wherein the suction charging line branches off from the fuel filter in the direction of the suction side of the feed pump and fuel can be introduced from an interior of a filter housing of the fuel filter into the suction charging line.

2. The fuel system according to claim 1, wherein the suction charging line branches off from a lower region of the filter housing when the fuel filter is in an installed position.

3. The fuel system according to claim 2, wherein the suction charging line is connected to the interior of the filter housing through a lower cover element of the lower region.

4. The fuel system according to claim 1, wherein the suction charging line is connected to the interior of the filter housing through a side wall of the fuel filter.

5. The fuel system according to claim 1, wherein a retention unit, in the region of which dirt particles are retained in the filter housing, is arranged upstream of an opening of the filter housing, which opening connects the interior of the filter housing and the suction charging line.

6. The fuel system according to claim 5, wherein the retention device comprises an impingement wall, which is arranged in the flow path between the interior of the filter housing and the suction charging line and upstream of the opening of the filter housing.

7. The fuel system according to claim 5, wherein the retention device comprises a filter element, which is arranged in the region of the opening of the filter housing.

8. The fuel system according to claim 1, wherein a float element of the emptying unit is arranged in the return reservoir and blocks an emptying line below a defined fuel filling level of the return reservoir, which emptying line connects the return reservoir to the suction charging line.

9. The fuel system according to claim 8, wherein a jet pump of the emptying unit is arranged in the suction charging line and is connected to the return reservoir via an emptying line, wherein the fuel conducted through the suction charging line during operation of the fuel system forms the driving medium of the jet pump and the fuel stored in the return reservoir forms the suction medium of the jet pump.

10. The fuel system according to claim 8, wherein the emptying unit has a check valve, which blocks the connection between the return reservoir and the jet pump when the pressure in the return reservoir falls below the suction pressure of the jet pump.

11. The fuel system according to claim 1, wherein the return line has a valve unit in a line region close to the combustion chamber, via which valve unit a connection between the combustion chamber and the return reservoir is switchable.

12. A gas turbine engine which is equipped with a fuel system according to claim 1.
